(19) United States
(12) Patent Application Publication
(10) Pub. No.: US 2013/0339488 A1
(43) Pub. Date: Dec. 19, 2013

(54) ENTERPRISE SERVICES FRAMEWORK FOR MOBILE DEVICES

(71) Applicants: Peter Eberlein, Malsch (DE); Bare Said, St. Leon (DE)

(72) Inventors: Peter Eberlein, Malsch (DE); Bare Said, St. Leon (DE)

(21) Appl. No.: 13/525,217

(22) Filed: Jun. 15, 2012

(51) Int. Cl. G06F 15/16

(52) U.S. Cl. 709/219

(57) ABSTRACT

Methods and apparatus, including computer program products, are provided for a mobile enterprise services framework. The method may include receiving, at a mobile services interface, a request for a service to access a structured data, the mobile services interface providing an application at a mobile device with at least one of a create, a read, an update, and a delete of the structured data; determining, at the mobile services interface, whether a wireless connection is available to enable communication to a remote server including a remote repository storing the structured data; and processing, at the mobile services interface, the request for the service locally by accessing a cached version of the structured data at the mobile device, when the wireless connection is not available to enable communication to the remote server including the remote repository storing the structured data. Related systems, methods, and articles of manufacture are also disclosed.

### FIELD

The subject matter described herein generally relates to data processing.

### BACKGROUND

Enterprise applications are not only high-performance business engines driving efficiencies, but also they are also flexible building blocks of business systems. A recent promising solution has risen in the form of services. A service, such as a web service, is a program representing a self-contained, self-describing piece of application functionality that can be found and accessed by other applications. A service is self-contained because the application using the service does not have to depend on anything other than the service itself, and self-describing because the description on how to use the service can be obtained from the service itself. The descriptions of the service are typically centrally stored and accessible through standard mechanisms, such as WSDL (Web Service Description Language).

Instead of requiring programmers to establish and maintain links between applications, services are loosely coupled, making connections simpler and more flexible and allowing application architects to more easily find and understand services offered by other cooperative applications. However, the problem that exists with services is that they are often designed to expose functionality of individual applications and thus are too limited to be efficient building blocks for enterprise-wide business processes. A solution to this shortfall has been the migration to a service oriented architecture (SOA). The SOA is an open architecture middleware, which builds on the benefits of services. The Enterprise Service Framework (ESF), which is commercially available from SAP AG, Walldorf, Germany, is an example of a SOA. The term “framework” refers to a structure of interrelated programs. The term “SOA” may also be used to refer to a distributed objects architecture, such as CORBA (Common Object Request Broker Architecture) and DCOM (Distributed Component Object Model).

The SOA enables the abstraction of business objects (business object), modeled as services (also referred to as enterprise services), from actual applications. Aggregating services into business-level enterprise services may provide more meaningful building blocks for the task of automating enterprise-scale business scenarios. The SOA also enables the use of a repository storing relevant pre-existing enterprise services, which can be made available to selected partners and customers. By using a repository, these selected partners and customers can use the pre-existing enterprise services to aid in the implementation of new services and corresponding business objects. The term business object (business object) represents an object, such as a data structure including data and operations, of significance to a business. Examples of business objects include a purchase order, a sales order, a flight reservation, a shipping order, customer information, employee information, and the like. A service may thus provide an interface to enable other services and applications to access and process (e.g., create, fill-in, save, query, delete, print, send, and the like) the business object. The proliferation of services and business objects as enterprise building blocks will continue, and, as such, software tools are required to facilitate their implementation.

### SUMMARY

Methods and apparatus, including computer program products, are provided for a mobile enterprise services framework. The method may include receiving, at a mobile services interface, a request for a service to access a structured data, the mobile services interface providing an application at a mobile device with at least one of a create, a read, an update, and a delete of the structured data; determining, at the mobile services interface, whether a wireless connection is available to enable communication to a remote server including a remote repository storing the structured data; and processing, at the mobile services interface, the request for the service locally by accessing a cached version of the structured data at the mobile device, when the wireless connection is not available to enable communication to the remote server including the remote repository storing the structured data.

In some implementations, the above-noted aspects may further include additional features described herein including one or more of the following. The mobile services interface may send the request for the service to the remote server including the remote repository storing the structured data, when the wireless connection is not available to enable communication. The mobile services interface may receive a response to at least one of the locally process request and the sent request. The mobile services interface may provide the response to the application. The structured data may include at least one business object.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the subject matter disclosed herein. In the drawings,

FIG. 1 illustrates a block diagram of an exemplary system including a mobile enterprise services framework, in accordance with some exemplary implementations;

FIG. 2 illustrates an exemplary schema of a business object; and

FIG. 3 illustrates a block diagram of another exemplary system including a mobile enterprise services framework, in accordance with some exemplary implementations; and

FIG. 4 illustrates a process for providing a mobile enterprise services framework, in accordance with some exemplary implementations.

### DETAILED DESCRIPTION

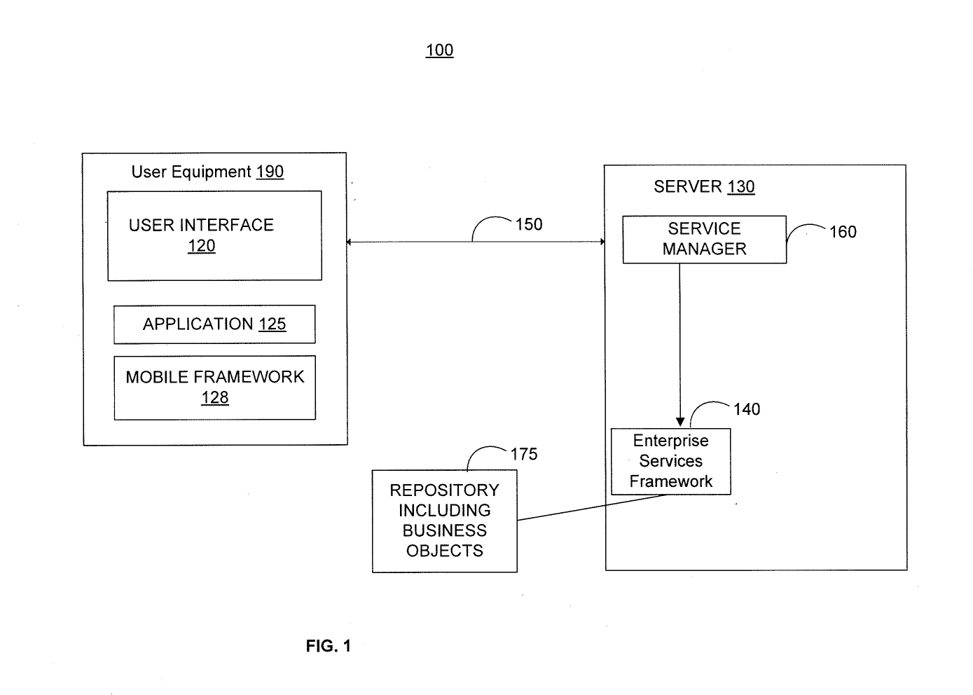

FIG. 1 is a block diagram of an exemplary system 100 configured to provide a mobile enterprise services framework, such as mobile framework 128. The system 100 further includes a user equipment 190 coupling to a server system 130 via at least a wireless access network 150.

The mobile framework 128 may be configured to provide applications, such as mobile applications hosted on user equipment 190, with a consistent interface to structured data, such as business objects. The mobile framework 128 may abstract connectivity status, so that regardless of whether there is an online connection to server 130 via wireless access network 150. As such, business objects at server 130 may be accessed through enterprise services framework 140 in substantially the same way, regardless of whether the user equipment 190 has an active connection via wireless access network 150. For example, application 125 may, based on mobile framework 128, access business objects through enterprise services framework 140 in substantially the same way, regardless of whether the user equipment 190 has an active connection via wireless access network 150.

In some exemplary implementations, user equipment 190 may be implemented as a mobile device and/or a stationary device. The user equipment 190 may be referred to as, for example, a mobile station, a mobile unit, a wireless terminal, a tablet, a smart phone, or the like. A user equipment may be implemented as, for example, a wireless handheld device, a wireless plug-in accessory, or the like. In some exemplary implementations, user equipment may include a processor, a computer-readable storage medium (e.g., memory, storage, and the like), a radio access mechanism configured to couple to a wireless network, and/or a user interface. Moreover, the storage medium may include instructions, such as code, which when executed provides user interface 120, application 125, mobile framework 125, and other components.

The user equipment 190 may further include a user interface 120 for viewing and/or accessing services at server 130 via wireless access network 150. The user interface 120 may be implemented as a browser, a thin client, and/or any other type of user interface.

In some implementation, the user equipment 190 may include an application 125, such as a mobile application. The application 125 may be implemented to access data, such as business objects at server 130. For example, mobile application 125 may be implemented as part of an enterprise services resource planning system. When this is the case, application 125 may be used as part of, for example, a workflow to process sales orders or to provide other business related processes, accessing structured data, such as business objects stored at the repository coupled to server 130.

The user equipment 190 may also include a mobile enterprise services framework, such as mobile framework 128. Mobile framework 128 may be configured to allow the mobile application 125 to access and access enterprise services framework 140 including business objects, regardless of whether the user equipment is online and thus has a connection to server 130, or offline and thus does not have a connection to server 130.

Although system 100 may be implemented as part of an enterprise services framework (ESF), other types of systems may be implemented as well. An enterprise services framework is a type of computer framework, such as a client-server architectural framework, that includes one or more services. The services of the ESF are accessible to other parts of the ESF, such as client systems and their corresponding users, through communication links, such as the Internet or an intranet. When system 100 is implemented as an ESF, system 100 may access enterprise services framework 140 to access those services. The enterprise services framework 140 may be implemented as instructions (e.g., a program, code, and the like) that performs a specific function and is designed in such a way to easily operate with other components and applications. Moreover, enterprise services framework 140 may be implemented as a self-contained, self-describing piece of program functionality that can be found and accessed by other programs. Although a service may be accessed through the Internet (or web), a service may be implemented to be accessible from an intranet or from an ESF.

The server 130 may include one or more processors, such as computers, to interface with other processors, such as user equipment 190. The server 130 may also include a computer-readable storage medium (e.g., memory, storage, and the like) including instructions, such as code, which when executed provides, service manager 160, enterprise services framework 140, and the like. In some implementations, the server 130 is coupled to a network, such as an intranet or the Internet, which is further coupled to other networks including a wireless network 150.

The service manager 160 may be used in some implementations to call a service at the enterprise services framework 140, and may couple to a repository 175, where structured data, such as business objects, are stored. The repository 175 may also store metadata associated with the business objects as well. When service manager 160 is implemented and calls from the user equipment 190 to the API of service manager 160 are made, an instance of service manager 160 is created at server system 130. When the API of service manager 160 is called, service manager 160 may also call a procedure to instantiate enterprise services framework 140 to provide a service, such as a create, read, update, delete, and the like of the structured data stored at repository 175. When instantiated by service manager 160, enterprise services framework 140 may also instantiate, one or more corresponding business objects. For example, a user of user interface 120 may access service manager 160 and enterprise services framework 140 to interact with a sales order having data and/or methods represented by a business object stored at least at repository 175. The data and methods associated with providing the sales order catalog to user interface 120 thus correspond to a business object. The term “node” may refer to a portion of the business object. Returning to the above sales order example, a business object node may refer to another object, such as a price or a product included within the business object.

In some implementations, a service manager 160 instance may include a message handler for handling messages to and from service manager 160; a change handler for handling changes affecting a service or a business object (e.g., changes that occur when user interface 120 changes, such as a button click, that affects a service or the corresponding business objects); and a controller for controlling dynamic properties of the instance (e.g., data fields that are mandatory, read-only, invisible, and the like). The service manager 160 may also include a stack for storing changes associated with the change handler in a last in, first out manner. Although service manager 160 is depicted within server 130, service manager 160 can be located anywhere and distributed among multiple locations.

The wireless access network 150 may include one or more of a cellular network, a public land mobile network, a wireless local area network, such as a WiFi network, and the like. For example, the wireless access network 150 may include one or more wireless links to a wireless access point, such as a cellular base station or a WiFi access point. The wireless access point may be further coupled to other networks, including the Internet, other wired networks, and/or any other network. In some exemplary implementations, user equipment 190 is a mobile device accessing wireless access network 150 via a cellular base station and/or WiFi wireless local area network access point. In this example, the cellular base station and/or WiFi wireless local area network access point may be coupled to other networks including wired and/or wireless networks, some of which may include the Internet, coupled to server 130.

The repository 175 may store information associated with the business objects (e.g., the product catalog service) including metadata for the business objects. For example, repository 175 may store a list of business object nodes including an identifier (ID) and data content. The ID of a business object refers to an identifying memory address of a business object node that uniquely identifies individual business object nodes within repository 175. The memory address can be used to access and read data content of a particular business object node. For example, an ID of a business object node may consist of a directory structure and filename associated with the business object node. The repository 175 may be implemented as an enterprise services repository, although any other computer-readable storage medium may be used.

The repository 175 may also store metadata regarding business objects. Metadata may be defined as data about data. For example, metadata may refer to information about the data itself, such as content, quality, condition, origin, size, formatting, characteristics of data, and the like. The eXtensible Markup Language (XML) is a specific example of metadata because it is a format used to define other data objects. Metadata may include a schema. A schema is the organization or structure, such as the organization of a database or the structure of an object in an object-oriented program. In object oriented programming, modeling (i.e., the analysis of objects that are used in a business or other context and the identification of the relationships among these data objects) leads to a schema, which can be stored in repository 175 as a schema. The schema can be depicted visually as a structure or a formal text-oriented description (e.g., script). The metadata may include information such as the number of nodes in a business object, the name(s) of the nodes, the position of a node in a business object hierarchy, the structure of a node, associations, actions, queries on a node, and the nature of a business object.

In some implementations, the predetermined specification for a service or business object may be representative of metadata. For example, the predetermined specification may specify one or more of the following metadata: the number of nodes in a business object, the name(s) of the nodes, the position of a node in the business object hierarchy, the structure of a node, associations, actions, queries on a node, and the nature of a business object.

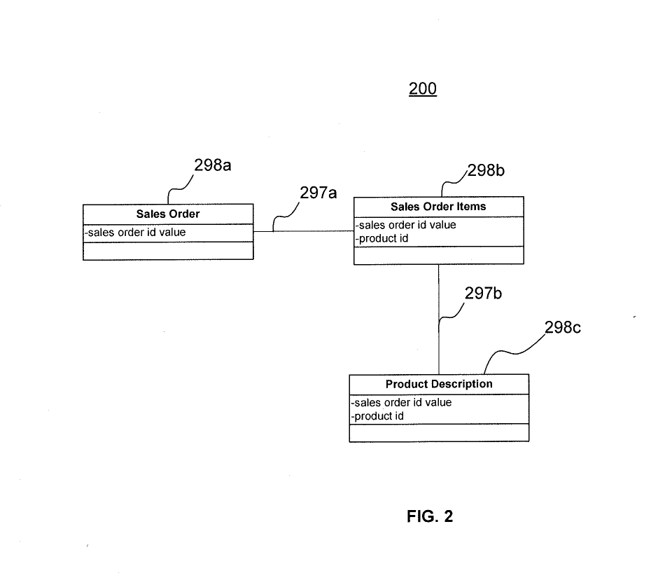

Before providing additional description with respect to system 100, the following describes an example of structured data, such as business objects. FIG. 2 depicts an example schema for a business object 200 including three business object nodes, namely a sales order 298a, sales order items 298b, and product description 298c. Moreover, the schema depicted in FIG. 2 may include keys 297a-b that identify the relationships among the business object nodes 298a-c. For example, key 297a is a sales order identification (“id”) value that is used to link business object nodes 298a and 298b, while key 297b links the product identification values (labeled at FIG. 2 as “product id”) of sales order item 298b and product description 298c. The schema, which depicts business object nodes and how they are associated to one another, may be considered metadata and stored in repository 175 along with any data associated with the business object.

Although FIG. 1 shows a single user equipment 190, a single network 150, and a single server system 130, other quantities and configurations of user equipment, networks, and servers may be used as well. Although FIG. 1 is described with respect to a client-server architecture and an ESF, system 100 can also use any other architecture or framework.

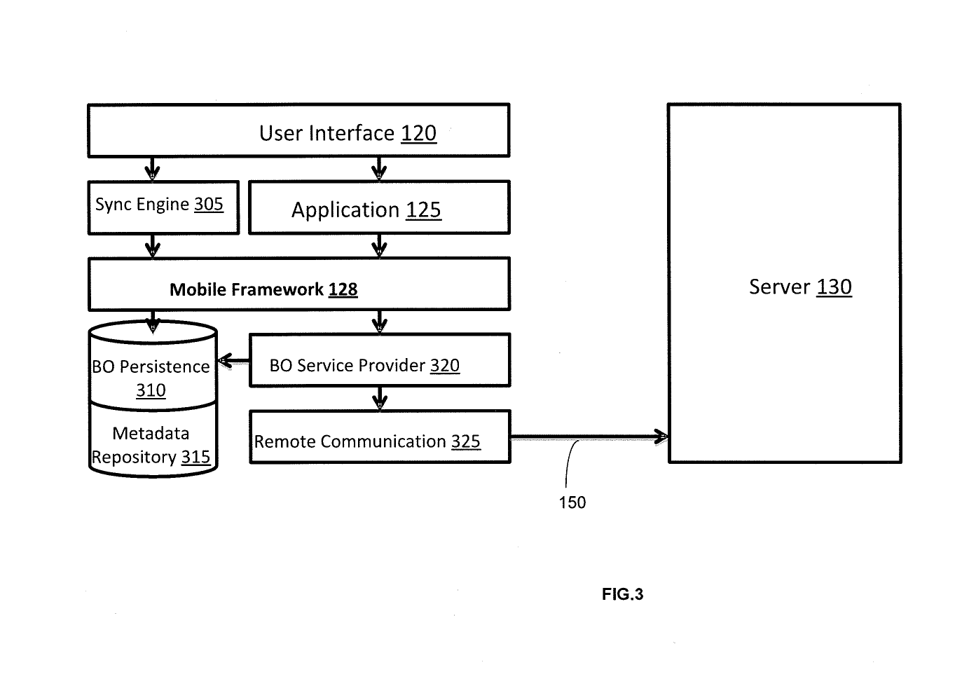

FIG. 3 is a block diagram of another exemplary system 300 configured to provide a mobile enterprise services framework, such as mobile framework 128. System 300 is similar to system 100 but includes additional features with respect to user equipment 190.

The user equipment 190 may further include a synchronization engine 305. The synchronization engine 305 provides synchronization by determining the set of business objects that are to be replicated while the user equipment 190 is online (i.e., connected to the server 130 via a wireless access network 150) in order to be able to access business objects, when the user equipment 190 is offline (i.e., not connected to the server 130 via a wireless network). The synchronization engine 305 may provide an interface which provides one or more services, such as create, read, update, and delete, to application 125 when accessing services including structured data (e.g., an enterprise services frame and business objects) stored at repository 175.

The mobile framework 128 may accesses by the synchronization engine and the application 125. The mobile framework 128 may also provide a consistent service interface to business objects being used by application 125. For example, the mobile framework 128 is configured to allow an application 125 to perform a function, such as a query, create, read, update, delete, and the like, of a business object node and invoke actions on them. Furthermore, the mobile framework 128 may also make metadata available to application 125 via repository 175 and/or persistent storage of business objects 310 and metadata 315.

The business object persistence 310 may provide storage for business objects created on user equipment 190 and/or replicated from server 130 to the user equipment 190 to provide business objects to application 125, when mobile framework is in an offline mode. When a business object is replicated from server 130 to the user equipment 190, this may be performed by the business object service provider 320 to ensure the presence of the business object even when the user equipment 190 is offline and thus lacks a wireless connection to the server 130.

The metadata repository 315 may include metadata concerning business objects. The mobile framework 128 may access this metadata to create a business object data structure in the business object persistence 310, to navigate the business object node hierarchy, and/or to provide static attributes about business object nodes and fields.

The business object service provider 320 may include specific business logic to access and provide business objects from the server 130 to the business object persistence 310. For example, updates to a business object node requested by a service consumer through the mobile framework 128 may be first validated by the business object service provider 320 (e.g., based on metadata from metadata repository 315) before an actual update in the business object persistence 310 is performed. When business objects are created, updated, deleted, and the like, the business object service provider 320 may call a corresponding service at the server 130 to maintain synchronization between the business object data at the server 130 including repository 175 and business object persistence 310 including metadata repository 315. Likewise, a query and read service call (which may not be directly provisioned by the mobile framework 128 via the business object persistence 310) may go through the business object service provider 320 to request data from the server 130, and the business object service provider 320 may then update local persistence at business object service persistence 310 and/or repository 315.

The remote communications interface 325 may provide high-level interfaces to the business object service provider 320 to abstract communication protocol details.

In some implementations, each business object may have an instance of business object service provider 320.

The following provides a description of one or more of the functions or services, which may be provided by the mobile framework 128 in an online mode and on an offline mode.

The mobile framework 128 may provide application 125 with a consistent interface to access business objects, nodes, fields, and properties. The mobile framework 128 may operate in an online mode (e.g., when there is no connection via at least wireless access network 150 to server 130), and the mobile framework 128 may operate in an offline mode (e.g., when there is no connection via wireless access network 150 to server 130). For example, in an offline mode, when the application 125 accesses a business object via the mobile framework 128, the mobile framework 128 may provide access to a business object cached locally at business object persistence 310. Moreover, the synchronization engine 305 may synchronize this locally cached business object with the business object stored at repository 175 when the mobile framework 128 returns to an online mode.

When the mobile framework 128 is in an online mode, the mobile framework 128 may provide application 125 with access to a create service. The create function allows the creation of new business objects at the server 130 including repository 175. When the business object is created, mobile framework 128 may stored a local copy of the created business object at the business object persistence 310.

When the mobile framework 128 is in an online mode, the mobile framework 128 may provide application 125 with a read service. The read allows application 125 to read via mobile framework 128 a business object stored at server 130 including repository 175. However, the mobile framework 128 may read a business object from local business object persistence 310, when the business object has recently been updated by server 130 and no explicit refresh from server 130 is demanded when the read service is invoked. Metadata data, such as properties of business objects, may be passed through as a set from server 130 including repository 175 to metadata repository 315. In some implementations, the mobile framework 128 may access other associated business object nodes, when reading a given business objects in order to reduce the quantity of round-trips between user equipment 190 and server 130. Moreover, metadata may be used to determine the other associated business object nodes.

When the mobile framework 128 is in an online mode, the mobile framework 128 may provide application 125 with an update service. For example, an update by the mobile framework 128 to a business object, nodes, and/or fields may be validated by the business object service provider 320 and then sent to server 130 for additional validation (e.g., cross checks against other business objects and business process status). If these updates are accepted, the local business object persistence 310 may be updated with a current state of the business object, node, or field.

When the mobile framework 128 is in an online mode, the mobile framework 128 may provide application 125 with a delete service. For example, deletes may be forwarded to server 130. Once confirmed by server 130, a local replica in the business object persistence 310 may be removed.

When the mobile framework 128 is in an online mode, the mobile framework 128 may provide application 125 with a synchronization service. For example, when the synchronization engine 305 determines that a business object should be refreshed with current data from server 130, the server 130 may invoke a synchronization service at the mobile framework 128. This synchronization service at the mobile framework 128 may read the most current data of the requested business object from the server 130 and update the local business object persistence 310.

When the mobile framework 128 is in an online mode, the mobile framework 128 may provide application 125 with a query service. For example, a query may immediately return matching business objects from the local business object persistence 310 but at the same time an asynchronous query call may be initiated to a backend service. Once this call returns, the mobile framework 128 consolidates the result set from this call with the one derived from the local business object persistence 310. When there is a difference, the mobile framework 128 notifies the mobile application 125 so it can refresh its user interface 120 with the full result.

When the mobile framework 128 is in an online mode, the mobile framework 128 may provide application 125 with an action service. The action function allows actions configured (or enabled) on business objects to be forwarded to the server 130 (which actions are enabled and which are disabled is communicated as a dynamic property by the read service). Examples of these enabled actions include SubmitForApproval, Approve, Reject, SendBackForRevision, and WithdrawFromApproval, and the like. Once the action has been executed, the resulting status update is retrieved from the server 130 and a local replica in the business object persistence 310 is updated.

When the mobile framework 128 is in an offline mode, the mobile framework 128 may provide application 125 with a create service. For example, a newly created business objects can be created by application 125 via mobile framework 128 while offline. When this is the case, the newly created business object may be stored in the local business object persistence 310 and recorded for sending to server 130 including repository 175, when the mobile framework 128 returns to an online mode. When entering data in new business objects, the functionality might be limited due to missing data. For example, cross-references to existing business objects may be created for those business objects that are available in the local business object persistence 310.

When the mobile framework 128 is in an offline mode, the mobile framework 128 may provide application 125 with a read service. The read function may deliver data to application 125 via mobile framework 128 from a local business object stored persistently at business object persistence 310, when mobile framework is offline. However, some data may not be not be available offline, in which case the user interface 120 may indicate that the data is not available. For example, a business object may be designated as having a dynamic property, in which case it would not be available offline. The dynamic property may be determined by business object service provider 325 based on available data. Both dynamic and static properties may be adjusted in post-processing before being returned by the read service based on metadata settings for the requested business object that determine if certain nodes or fields are editable or which actions are enabled when offline. This allows enabling offline updates for business objects that can be automatically reconciled if concurrent updates happen during the offline period or if a “last-one-wins” update strategy is acceptable. On the other hand, some business objects may be defined so that they are disabled for offline updates. Business objects that were created offline and not yet sent to the server 130 may be excluded from this property post-processing.

When the mobile framework 128 is in an offline mode, the mobile framework 128 may provide application 125 with an update service. For example, the update may be disabled while offline. For those nodes and fields that allow offline updates, changes are stored in the business object persistence 310 and recorded for sending to the server 130 when the connection returns to an online mode. If multiple updates to the same node or field occur (or if an entity is first created and then updated while still offline), the changes are aggregated before sending them to the server 130.

When the mobile framework 128 is in an offline mode, the mobile framework 128 may provide application 125 with a delete service. The delete may also be disabled by properties. However, if enabled, business objects are removed from the local business object persistence 310 and deletion is recorded for sending to the server 130, when the mobile framework 128 returns to an online mode.

When the mobile framework 128 is in an offline mode, the mobile framework 128 may provide application 125 with a synchronization service. The synchronization engine may be decoupled from the mobile framework 128. When this is the case, the mobile framework 128 may invoke synchronization services while in an offline mode. When offline, a request for synchronizing the business objects at the user equipment and server may be recorded for later execution, when the mobile framework returns to an online mode. In some implementations, this synchronization request may be executed by the mobile framework 128 at a lower priority than other functions, such as create, update, delete, and action service calls. Multiple synchronization requests (or service calls) for the same business object (or business object node) may be combined before being sent to server 130 for execution.

When the mobile framework 128 is in an offline mode, the mobile framework 128 may provide application 125 with a query service. The query service may be executed on local business objects stored at persistence 310, but a parallel asynchronous query may not be sent to the server 130.

When the mobile framework 128 is in an offline mode, the mobile framework 128 may provide application 125 with an action service. For example, actions can be enabled or disabled via properties, as noted. The properties may be processed locally at the user equipment 190 and, in particular, the business object service provider 320, when enabled. Actions may cause status changes that may need to be evaluated by a status and action framework and, in order to yield the same results as if executed in the server 130, the mobile business object service provider 320 may execute the same status and action model. To keep in synchronization with the server 130, the action may be recorded for sending to the server 130, when the connection goes online again.

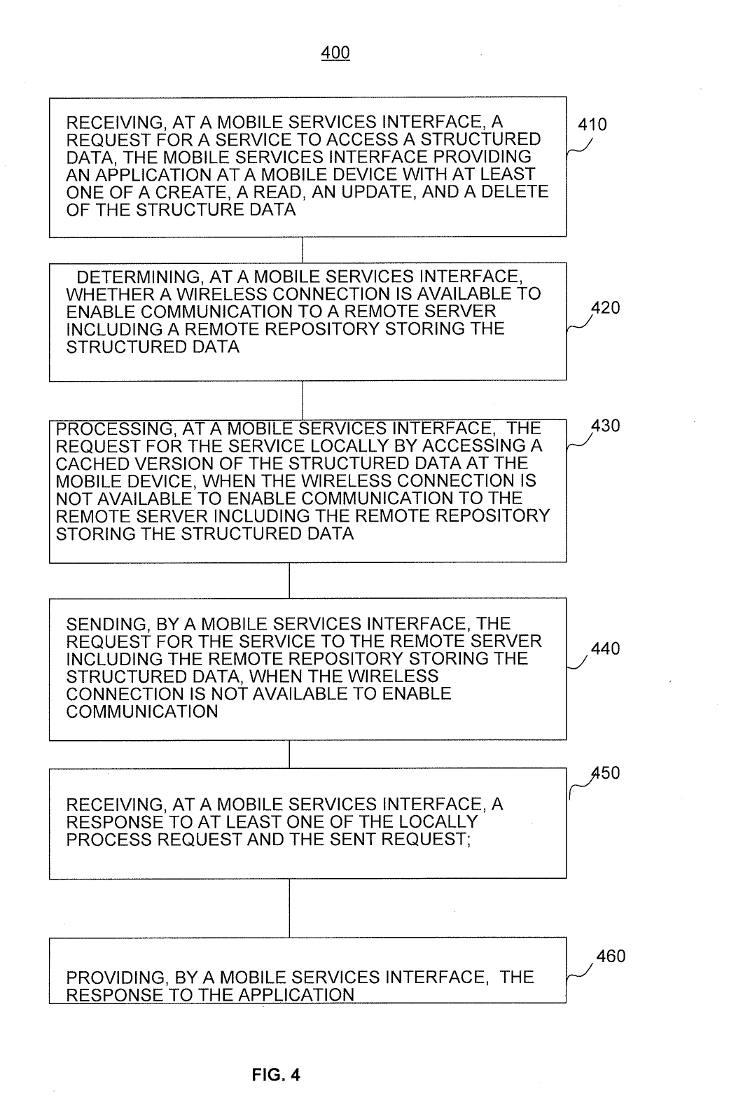

FIG. 4 depicts an example of a process 400 for a mobile enterprise services framework, in accordance with some exemplary implementations.

At 410, a mobile services interface, such as mobile framework 128, may receive, from application 125, a request for a service to access structured data, The mobile framework 128 may be configured to provide application 125 with at least one service, such as a create, a read, an update, and a delete of the structured data. The structured data may correspond to business objects, which may be cached locally at business object persistence 310 or stored remotely at repository 175.

At 420, the mobile services interface, such as mobile framework 128, may determine whether a wireless connection is available to enable communication to a remote server, such as server 130, including a remote repository, such as repository 175.

At 430, the mobile services interface may process the request for the service locally by accessing a cached version of the structured data at the mobile device, when the wireless connection is not available to enable communication to the remote server including the remote repository storing the structured data.

At 440, the mobile services interface may send the request for the service to the remote server including the remote repository storing the structured data, when the wireless connection is not available to enable communication.

At 450, the mobile services interface may receive a response to at least one of the locally processed request and the sent request, and, at 460, the mobile services interface may provide the response to the application, which may present the response at user interface 120.

The systems and methods disclosed herein may be embodied in various forms including, for example, a data processor, such as a computer that also includes a database, digital electronic circuitry, firmware, software, or in combinations of them. Moreover, the above-noted features and other aspects and principles of the present invention may be implemented in various environments. Such environments and related applications may be specially constructed for performing the various processes and operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

The systems and methods disclosed herein may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

The foregoing description is intended to illustrate but not to limit the scope of the invention, which is defined by the scope of the appended claims. Other aspects are within the scope of the following claims.

What is claimed:

1. A method comprising:
receiving, at a mobile services interface, a request for a service to access a structured data, the mobile services interface providing an application at a mobile device with at least one of a create, a read, an update, and a delete of the structured data;
determining, at the mobile services interface, whether a wireless connection is available to enable communication to a remote server including a remote repository storing the structured data; and
processing, at the mobile services interface, the request for the service locally by accessing a cached version of the structured data at the mobile device, when the wireless connection is not available to enable communication to the remote server including the remote repository storing the structured data.

2. The method of claim 1 further comprising:
sending, by the mobile services interface, the request for the service to the remote server including the remote repository storing the structured data, when the wireless connection is not available to enable communication.

3. The method of claim 1 further comprising:
receiving, at the mobile services interface, the response to at least one of the locally processed request and the sent request.

4. The method of claim 1 further comprising:
providing, by the mobile services interface, the response to the application.

5. The method of claim 1, wherein the structured data comprises a business object.

6. An apparatus comprising:
at least one processor; and
at least one memory including code, which when executed by the at least one processor provides operations comprising:
receiving, at a mobile services interface, a request for a service to access a structured data, the mobile services interface providing an application at a mobile device with at least one of a create, a read, an update, and a delete of the structured data;
determining, at the mobile services interface, whether a wireless connection is available to enable communication to a remote server including a remote repository storing the structured data; and
processing, at the mobile services interface, the request for the service locally by accessing a cached version of the structured data at the mobile device, when the wireless connection is not available to enable communication to the remote server including the remote repository storing the structured data.

7. The apparatus of claim 6 further comprising:
sending, by the mobile services interface, the request for the service to the remote server including the remote repository storing the structured data, when the wireless connection is not available to enable communication;

8. The apparatus of claim 6 further comprising:
receiving, at the mobile services interface, a response to at least one of the locally processed request and the sent request.

9. The apparatus of claim 6 further comprising:
providing, by the mobile services interface, the response to the application.

10. The apparatus of claim 6, wherein the structured data comprises a business object.

11. A non-transitory computer-readable medium comprising code, which when executed by at least one processor provides operations comprising:
receiving, at a mobile services interface, a request for a service to access a structured data, the mobile services interface providing an application at a mobile device with at least one of a create, a read, an update, and a delete of the structured data;
determining, at the mobile services interface, whether a wireless connection is available to enable communication to a remote server including a remote repository storing the structured data; and
processing, at the mobile services interface, the request for the service locally by accessing a cached version of the structured data at the mobile device, when the wireless connection is not available to enable communication to the remote server including the remote repository storing the structured data.

12. The non-transitory computer-readable medium of claim 11 further comprising:
sending, by the mobile services interface, the request for the service to the remote server including the remote repository storing the structured data, when the wireless connection is not available to enable communication;

13. The non-transitory computer-readable medium of claim 11 further comprising:
receiving, at the mobile services interface, a response to at least one of the locally processed request and the sent request.

14. The non-transitory computer-readable medium of claim 11 further comprising:
providing, by the mobile services interface, the response to the application.

15. The non-transitory computer-readable medium of claim 11, wherein the structured data comprises a business object.
